(19) United States
(12) Patent Application Publication
(10) Pub. No.: US 2016/0046372 A1
(43) Pub. Date: Feb. 18, 2016

(54) Rocket Morphing Aerial Vehicle

(71) Applicant: L'Garde, Inc., Tustin, CA (US)

(72) Inventors: Nathaniel C. Barnes, Irvine, CA (US); Amir Shahram Gohardani, Irvine, CA (US)

(21) Appl. No.: 14/722,104

(22) Filed: May 26, 2015

Related U.S. Application Data
(60) Provisional application No. 62/002,726, filed on May 23, 2014.

(51) Int. Cl. B64C 39/02; B64D 17/80; B64F 1/10

(52) U.S. Cl. CPC B64C 39/024; B64F 1/10; B64D 17/80; B64C 2201/024; B64C 2201/082

(57) ABSTRACT

A rocket morphing aerial vehicle has a first rocket configuration and a second aerial vehicle configuration. The rocket morphing aerial vehicle may be used to deploy an aerial vehicle at further distances faster. The rocket configuration may be used to get the aerial vehicle to its desired location, while the aerial vehicle is used for the desired task. The rocket morphing aerial vehicle may include a deceleration mechanism such that the speed of the rocket does not interfere with the deployment of the aerial vehicle.

### PRIORITY

This application claims priority to U.S. Provisional Application No. 62/002,726, filed May 23, 2014, titled “Rocket Morphing Aerial Vehicle,” which is incorporated by reference in its entirety into this application.

### BACKGROUND

Mobile, instantaneous aerial surveillance platforms are crucial for a wide range of applications including rescue operations, disaster or conflict monitoring, and terrestrial surveillance. Currently, deployed Unmanned Aerial Vehicles (UAVs) launched from the ground do not offer such an aerial vehicle surveillance capability despite the availability of sophisticated surveillance instruments. The main factor limiting the performance of today's ground-launched UAVs is the time lapse to reach appropriate surveillance altitudes due to the limited aerial propulsion and power levels of standard electrical and air-breathing propulsion systems. This limitation prohibits immediate aerial surveillance capability for many terrestrial applications.

### SUMMARY

Embodiments described herein include a rocket morphing aerial vehicle (RMAV) that has at least two configurations. The RMAV comprises a rocket configuration that may be used to launch the RMAV to get the RMAV to a desired location for aerial vehicle deployment. The RMAV also comprises an aerial vehicle configuration. Aerial vehicles typically employ one or a multiple of propulsors. A propulsor may be an engine, fan, propeller, rotor, or any other device which contributes to aerial vehicle propulsion. The proposed design enables a stowed single- or multi-propulsor aerial vehicle, mounted inside a launching rocket, and provides for the subsequent vehicle deployment for rapid response aerial surveillance. The Aerial Vehicle may also comprise a propulsor-driven inflatable vehicle, featuring deployable wings or fuselage with a capability to transform from a stowed configuration to a deployable shape. The benefit of this concept is the actual transformation of a low stowage volume aerial vehicle package, which, upon deployment, is represented by a larger morphing aerial vehicle.

### DRAWINGS

FIG. 1 illustrates an exemplary rocket morphing aerial vehicle according to embodiments described herein in a stored configuration.

FIGS. 2A-2B illustrates an exemplary rocket morphing aerial vehicle according to embodiments described herein in a deployed configuration.

FIG. 3 illustrate an exemplary design of the rocket morphing aerial vehicle concept operated in five steps from launch to full aerial vehicle deployment according to embodiments described herein.

FIGS. 4A-4B is an alternate embodiment of an exemplary rocket morphing aerial vehicle according to embodiments described herein.

FIG. 5 illustrates a cross section of an exemplary Rocket Morphing Aerial Vehicle concept according to embodiments described herein in a stored configuration.

### DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

To enable a more rapid, robust and on-demand aerial surveillance platform, a novel hybrid design approach which synergistically merges conventional rocket launch technology with state-of-the art aerial vehicle technology is described here. This design may incorporate reusable, disposable, and combinations thereof of navigation, surveillance, and automation technology and components. Aerial vehicles typically employ one or a multiple of propulsors. A propulsor may be an engine, fan, propeller, rotor, or any other device which contributes to aerial vehicle propulsion. The proposed design enables a stowed single- or multi-propulsor aerial vehicle, mounted inside a launching rocket, and provides for the subsequent vehicle deployment for rapid response aerial surveillance. The Aerial Vehicle may also comprise a propulsor-driven inflatable vehicle, featuring deployable wings or fuselage with a capability to transform from a stowed configuration to a deployable shape. The benefit of this concept is the actual transformation of a low stowage volume aerial vehicle package, which, upon deployment, is represented by a larger morphing aerial vehicle.

Although embodiments of the invention may be described and illustrated herein in terms of rocket morphing capabilities into unmanned aerial vehicles (UAVs), it should be understood that embodiments of this invention are not so limited, but are additionally applicable to rocket morphing capabilities into other vehicles in which the rocket is preferably slowed and/or directed before deployment of the vehicle from the rocket. Furthermore, although embodiments of the invention may be described and illustrated herein in terms of a vehicle morphing from a rocket, it should be understood that “rocket” is not limited to self-propelled projectiles, but also includes those that are ejected from a launcher and are propelled by the external fire power of the launcher.

Typical high-speed rocket launches are not compatible with the deployment of aerial surveillance vehicles, primarily because the velocity of the rocket is much greater than what a low-speed aerial vehicle, designed for a localized surveillance task, is able to accommodate in controlled flight. Hence, a method of deceleration is required. A wide range of deceleration techniques including combined wingsuits and parachutes, or drogue chutes, as well as stand-alone deceleration mechanisms of these deceleration devices can be employed for this purpose. An objective of the deceleration technique is to minimize structural loading on the deployed aerial vehicle and to assist with a maneuverable deployment sequence.

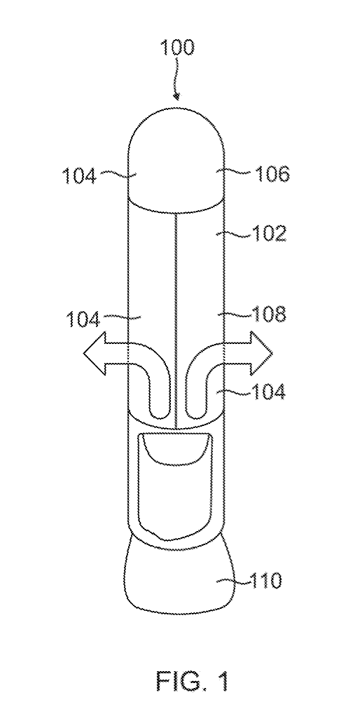

FIG. 1 illustrates an exemplary rocket morphing aerial vehicle (RMAV) according to embodiments described herein in a rocket configuration. The exemplary rocket morphing aerial vehicle 101 provides one particular aerial surveillance concept, which also includes deceleration mechanisms 102.

The exemplary rocket morphing aerial vehicle 101 includes a rocket body wall 104 enclosing a body interior. The rocket body wall 104 may define different portions of the rocket, including the nose 106, the body 108, and the nozzle 110. The nose 106 may be aerodynamically configured to cover the rocket body end and contribute to a desired trajectory and flight characteristics as is known in the art. The rocket body may also have an opening section to expose or remove the UAV.

The UAV may deploy from the rocket body. The UAV may have a stowed configuration and a deployed configuration, where the stowed configuration is smaller than the deployed configuration. In an exemplary embodiment, the UAV may be integrated with the rocket body, such that a portion of the UAV defines a portion of the rocket body wall. In other embodiments as described herein, the UAV may be separate from and enclosed by the rocket body wall.

The deceleration mechanism 102 may be integrated with or separate from the rocket body. For example, the deceleration mechanism may be a portion of the UAV, a portion of the rocket body, an opening, or other component or combination used to slow the rocket before or as the UAV is deployed. The deceleration mechanism may include other components such as parachutes, veins, sails, glides, wings, fins, etc.

The RMAV may include sensors, controllers, and other hardware and/or software components to control the deployment of the rocket. For example, sensors to measure acceleration, altitude, pressure, speed, temperature, position, and other conditions or parameters may be used to determine the location, orientation, position along a trajectory, and combinations thereof to determine when the RMAV should deploy. In an exemplary embodiment, a set of sensors may be used to deploy the RMAV at a desired altitude or at a desired point on the trajectory, such as the apogee. The sensors may be used in conjunction with the deceleration mechanism(s) to control trajectory during the deceleration by extending flaps, fins, wings, sails, etc. to a given extent in a given combination to guide the deployment to a desired location.

The rocket diameter of the RMAV may be between 4 and 16 inches with a preferable range of 6-8 inches. The actual size is determined by the weight of the aerial vehicle, which can be between 10 and 50 pounds, with a preferable weight of 20-30 pounds. Additional design constraints of the RMAV are driven by the weight and size of the aerial vehicle, and may be restricted to ensure an almost instantaneous aerial surveillance capability following the rocket launch.

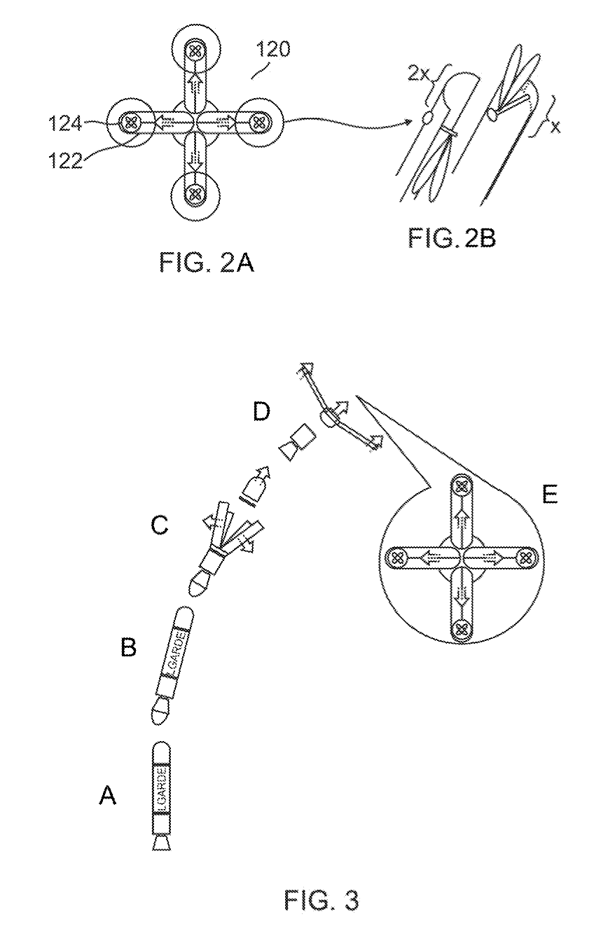

FIG. 2A illustrates an exemplary rocket morphing aerial vehicle according to embodiments described herein in a deployed configuration in which the rocket configuration has morphed into the UAV configuration. The UAV 120 of FIG. 2A comprises a portion that defines or was a portion of the rocket wall in the rocket configuration. As illustrated, a quad copter is provided in which four arms 122 extend radially from a central hub and support four propulsors 124. The arms are curved such that the arms form a portion of the cylindrical body of the rocket when stowed. Accordingly, the arm may be curved, such as semi-circular, in the cross-section taken perpendicular to the arm length. In the stowed or rocket configuration, the arms in the lengthwise direction are generally parallel. In exemplary embodiments, the centers of curvature of the arms are concentric. The arms may fully circumscribe the rocket body when stowed or may partially circumscribe the rocket body. The arms may be hinged, bendable, inflatable, or otherwise rotatable such that the arms translate from parallel in the stowed configuration to radial in the deployed configuration.

Each of the arm ends supports a propulsor 124. The propulsors 124 may also be deployable. For example, the propulsors may include blades that align with the arm and may compress into the curvature of the arm when stowed. The propulsors may extend or translate relative to the arm such that they extend above or outside of the arm profile when deployed. For example, the propulsors or other components of the UAV or RMAV may comprise springs, gas ejectors, folded inflatables, and stored-energy hinges to deploy one or more portions of the system, including, for example, the propulsors. The propulsors may be biased in the deployed configuration such that once the arms deploy, the propulsors automatically deploy. The propulsors may be deployed by translating longitudinally along the arm such that in a stowed configuration, the propulsors may be staggered within the rocket body. The propulsors may be deployed by extending away from the surface of the arm such that they are more compact in the stowed configuration.

In an exemplary embodiment, the propulsors do not translate along or away from the arm. If multiple propulsors are used, the propulsors may be staggered in their length away from the hub or center of the UAV, such that two or more of the propulsors do not align or overlap as seen in profile in the stowed configuration. The blade may be configured in a stowed configuration and deployed configuration. In an exemplary embodiment, as shown in FIG. 2B, the blades may extend in the same direction in the stowed configuration such as toward the nose of the rocket, while blades on an opposing arm may extend in the opposite direction, such as toward the nozzle of the rocket. Therefore, the blades may not take up the same space as blades on opposite arms and may be accommodated within the rocket body with only small or no offsets at the base of the propulsors.

In an exemplary embodiment, the propulsors extend past the terminal end of the arm portion that functions as the rocket body portion. The propulsors may be enclosed, at least partially, by a different portion of the rocket body or nose, such that when deployed, the arm does not interfere with the propulsors.

In an exemplary embodiment, the number of arms and propulsors may be changed, such as one, two, three, four, or more. The arms may also take on different shapes and functions. For example, the arms may be wings and the rocket body wall used as a UAV body. The propulsors may then be on an end of the UAV body and contained within the rocket body in the collapsed configuration. The arms may extend from within the rocket body or may form part of the rocket body.

FIG. 3, steps A-E illustrate an exemplary design of the rocket morphing aerial vehicle concept operated in five steps from launch to full aerial vehicle deployment according to embodiments described herein.

FIG. 3A illustrates the RMAV in its collapsed or rocket configuration. The rocket is then launched as seen in FIG. 3B. The rocket may be launched under its own propulsion or as a projectile using an external accelerant such as a launcher. The deployment is initiated in FIG. 3C. As shown, the deceleration mechanism(s) deploy to slow and/or control the trajectory of the RMAV to a desired deployment location. The deployment shown includes a portion of the rocket body wall extending outward to act as flaps and slow the RMAV. The deployment may also be assisted by the deceleration mechanisms as the air will engage the flaps and continue to push them outward to fully deploy and slow the RMAV. As shown in the embodiment of FIG. 3C, the deceleration mechanism is part of the rocket body as well as part of the UAV. As shown by arrows in FIG. 3C, the rocket body wall separate and rotate about the UAV hub and extend outward. The nose and rocket nozzle separate, leaving the UAV deployed in FIG. 3D. At FIG. 3E, the UAV may then be manipulated remotely or programmed to run automatically over the desired location.

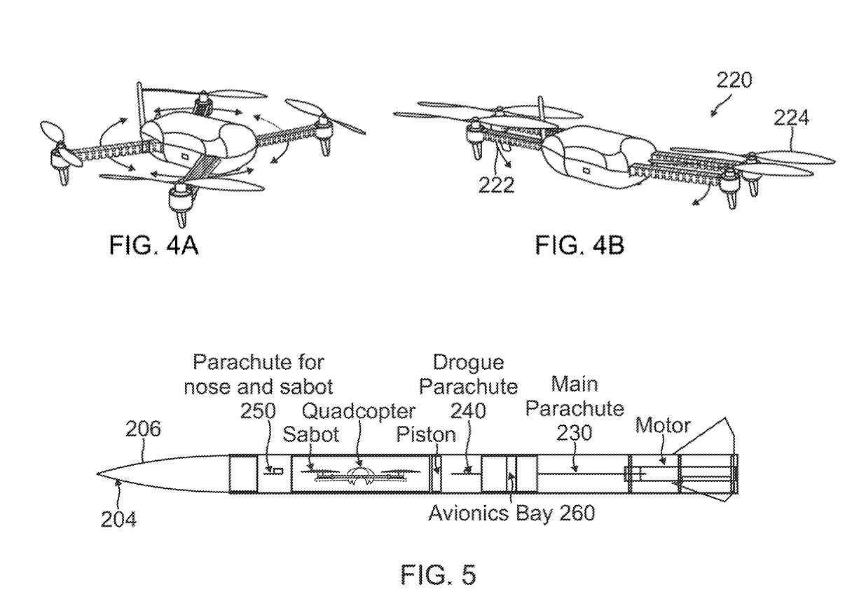

FIGS. 4A-4B is an alternate embodiment of the UAV of an exemplary RMAV according to embodiments described herein. FIG. 4A illustrates the exemplary UAV in a deployed configuration, while FIG. 4B illustrates the exemplary UAV in a stowed configuration. The exemplary embodiment of the UAV 220 is deployable from within a rocket body 204. The UAV 220 may be very small such that one or more fit within a section of the rocket body in a deployed configuration, or in a collapsed configuration. For example, more than two UAVs may be positioned side by side either radially or longitudinally along the rocket body, or positioned front to back. The UAVs may also be configured such that the collapsed configurations mate or cooperate such that the collapsed configuration is minimized across multiple UAVs. The multiple UAVs may then be operated in tandem or together during the surveillance or mission as desired. The UAVs may be preprogrammed, manually controlled, or combinations thereof. For example, a set of UAVs may have a preprogrammed configuration with respect to one another, but may be manually controlled across the group as compared to a target object external to the set of UAVs.

In an exemplary embodiment, the UAV 220 includes one or more arms 222, each arm 222 supporting one or more propulsors 224. Four arms are shown, but any number of arms may be used. The arms may rotate about the vertical axis of the hub or UAV body such that the arms may be stowed by being positioned generally linearly or parallel along a length of the UAV body; thereby reducing a width dimension of the UAV. The UAV may then be deployed once it is removed from the rocket body by rotating the arms about the hub to separate adjacent arms and position the arms about the hub body. The arms may be biased such that they automatically deploy when the UAV is removed from the rocket body or may be controlled by the UAV body or other external force after or during the deployment of the UAV from the rocket body.

FIG. 5 illustrates a cross section of an exemplary rocket morphing aerial vehicle concept according to embodiments described herein in a stored configuration. Notional design of the RMAV concept (in this specific case, a multi-propulsor aerial vehicle such as a quadcopter) used in performed simulations.

An exemplary embodiment includes a rocket body 204 that encloses the UAV 220 and other deployment components including a deceleration mechanism. The rocket includes rocket nose 206 designed for specific aerodynamic properties of the rocket. The rocket nozzle 210 may include the fuel, motor, and other accelerants to launch and drive a self-propelled rocket. External force or accelerants may also be used, such that the nozzle may instead simply include fins or other stabilizers.

The RMAV 200 may include a deceleration mechanism 202 for slowing the rocket and/or UAV prior to UAV deployment. As shown, the deceleration mechanism 202 may be a parachute 230, 240, 250 that deploys from the nose, nozzle, or body of the rocket as is attached to either the rocket body or the UAV. The end of the rocket may separate, exposing the parachute or the parachute may deploy from an end or side of the rocket body. Other deceleration mechanisms may be used in addition or instead of the parachute. For example, the rocket body may deform to decelerate the RMAV. The rocket body may include fins, holes, wings, or other features that extend from the body to slow the rocket before UAV deployment. In an exemplary embodiment, the nose of the rocket is ejected, thus leaving a flat frontal surface to slow the rocket.

Once the desired altitude, speed, location, time, or combination thereof have been achieved, the UAV 220 may be deployed from the rocket body 208. The UAV may be removed from the rocket body, for example by a second parachute 240 or the rocket body may be removed from around the UAV. The rocket body 204 may include a parachute 230 and/or the nose 206 may also include a parachute 250 such that the rocket parts are kept from falling too fast to the ground for safety or recovery objectives.

The rocket may also include avionics 260 to control the RMAV 200. The avionics may include altimeter, accelerometer, GPS, clock, timer, and other sensors to determine time, location, altitude, etc. for controlling deployment.

Two mission events may determine the operation of the RMAV concept depicted in FIG. 5. A first event may be triggered by the altimeters at apogee (or pre-determined altitude) which cause a black powder ejection charge to be fired or other known configurations of separation devices to separate the vehicle at the nose. This event may be used to also pull a sabot out of the upper body, subsequently opening and ejecting the aerial vehicle. The sabot and nose may be connected via a shock cord and kept away from the aerial vehicle with a parachute, which also permits safe recovery of this reusable unit. That same event also pushes out the drogue parachute for the balance of the dismantled vehicle. During descent of the launch vehicle, a second event is triggered by the altimeters at a specified altitude—typically 600-800 feet above ground level, hence, pushing out the main parachute to return the balance of the vehicle safely to the ground for re-use. The subsequent soft descent and landing permit recovery of all but the launch rocket main body, significantly reducing the cost of each surveillance mission.

Therefore, an exemplary method of deploying a UAV using a RMAV includes first launching the Rocket Morphing Aerial Vehicle (RMAV). The launch may be under the propulsion of the RMAV itself or by being launched as a projectile by an external propellant. Then, the rocket maintains its flight path to reach apogee or a pre-designated deployment altitude. Next, the stowed aerial vehicle package is deployed mechanically, pyrotechnically or by any other known conventional methods. In a first embodiment, the deployment mechanism may use the body of the rocket as a support structure of the single- or multi-propulsor aerial vehicle. In a second embodiment, the stowed single- or multi-propulsor aerial vehicle is distinctly separate from the rocket body. Both designs employ a deceleration device which may be activated prior or during deployment of the aerial vehicle. Based on the considered deployment methods, the aerial vehicle is fully deployed from the deployed aerial vehicle package. Finally, the single- or multi-propulsor aerial vehicle becomes operational for aerial surveillance purposes. Once the aerial vehicle is fully deployed and the propulsion system operational, all surveillance instruments and data communication systems are activated, and images of the scene below the aerial vehicle may be transmitted to a remote receiving station or stored on board in the vehicle memory for recovery and analysis.

A wide range of design and operational parameters are possible with this innovative concept and fall within the scope of this invention; some typical payload weights and mission performance specifications can be determined for some nominal rocket sizes and launch altitudes and are shown below. Preliminary analysis has been performed for three apogee altitudes of 1,000 feet, 2,000 feet, and 3,000 feet, with rocket diameters ranging between 6 inches to 8 inches. Simulation results for several different launch scenarios have been considered in Tables 1-4. For these sets of the design criteria, a predefined requirement has been established for the rocket to reach apogee within 60 seconds, although longer fly-out times are certainly Possible with this concept.

TABLE 1
Simulation RMAV parameters.

| | Vehicle | | | Payload | |
|---|---|---|---|---|---|
| | Diameter | Length | Weight | | Weight |
| Name | (cm) | (cm) | (kg) | Type | (kg) |
| 6 inches Quad | 15.7 | 340 | 15.2 | Quad Copter | 2.26 |
| Boost | | | 15.3 | Quad Copter | 2.26 |
| | | | 15.5 | Quad Copter | 2.26 |

TABLE 2
Simulation results for Table 1 RMAV and the time to reach apogee.

| Engine | | | | Flight | | | |
|---|---|---|---|---|---|---|---|
| | | Total | | | Max | | |
| | | Impulse | Average | Altitude | Velocity | Time to | Descent |
| Code | Size (mm) | (N-Sec) | Thrust (N) | (m) | (km/h) | Apogee (s) | Rate (m/s) |
| K665BB | 54 | 1198 | 744 | 317 | 71 | 8.9 | 6.4 |
| K635-RL | 54 | 1973 | 630 | 632 | 101 | 12.6 | 6.5 |
| K590-Dt | 54 | 2415 | 561 | 909 | 116 | 14.7 | 6.6 |

TABLE 3
Simulation RMAV parameters.

| | Vehicle | | | Payload | |
|---|---|---|---|---|---|
| | Diameter | Length | Weight | | Weight |
| Name | (cm) | (cm) | (kg) | Type | (kg) |
| 8 inches Quad | 20.3 | 353 | 19.9 | Quad Copter | 2.26 |
| Boost | | | 19.9 | Quad Copter | 2.26 |
| | | | 22.3 | Quad Copter | 2.26 |

TABLE 4
Simulation results for Table 3 RMAV and the time to reach apogee.

| Engine | | | | Flight | | | |
|---|---|---|---|---|---|---|---|
| | | Total | | | Max | | |
| | | Impulse | Average | Altitude | Velocity | Time to | Descent |
| Code | Size (mm) | (N-Sec) | Thrust (N) | (m) | (km/h) | Apogee (s) | Rate (m/s) |
| K671RR | 54 (adapt.) | 1802 | 681.3 | 306 | 66 | 9.1 | 6.2 |
| K1440WT | 54 (adapt.) | 2368 | 1427 | 583 | 105 | 11.4 | 6.3 |
| L890SS | 75 | 3695 | 894 | 1001 | 129 | 15.7 | 6.4 |

Simulation analysis indicates that a 60 second aerial surveillance capability is feasible for apogee altitudes of 1,000 feet; 2,000 feet; and 3,000 feet. Following an aerial surveillance mission by a fully autonomous aerial vehicle in unstructured environments with on-board sensing and processing capabilities, the UAV may further navigate itself back to the recorded Global Positioning System (GPS) point from which it began its original surveillance mission. Hence, a versatile product comprising a rocket embedded with a deployable single- or multi-propulsor aerial vehicle system enables a reusable aerial vehicle featuring instantaneous navigation, surveillance, and automation capabilities.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

The invention claimed is:

1. A rocket morphing aerial vehicle having a first rocket configuration and a second aerial vehicle configuration different from the rocket configuration, comprising:
a rocket body, the rocket body having a generally cylindrical body portion and a nose portion;
an aerial vehicle within the rocket body and deployable from the rocket body; and
a deceleration mechanism configured to reduce the speed of the rocket morphing aerial vehicle before or during deployment of the aerial vehicle.

2. The rocket morphing aerial vehicle of claim 1, wherein the aerial vehicle is separate from and fully contained within the rocket body.

3. The rocket morphing aerial vehicle of claim 2, wherein deceleration mechanism is a parachute configured to be deployed prior to full deployment of the aerial vehicle.

4. The rocket morphing aerial vehicle of claim 2, wherein the rocket body encloses a main parachute, avionics, the aerial vehicle, and an aerial vehicle parachute.

5. The rocket morphing aerial vehicle of claim 4, wherein the rocket morphing aerial vehicle is configured to separate the nose portion from the body portion of the rocket body, wherein the separation of the nose portion is configured to eject the aerial vehicle from the rocket body and deploy the aerial vehicle parachute.

6. The rocket morphing aerial vehicle of claim 5, wherein the rocket morphing aerial vehicle is configured to deploy the main parachute.

7. The rocket morphing aerial vehicle of claim 6, wherein the separation of the nose portion of the rocket morphing aerial vehicle is configured to occur at a first altitude, and the deployment of the main parachute is configured to occur at a second altitude.

8. The rocket morphing aerial vehicle of claim 6, wherein the aerial vehicle is a quad copter.

9. The rocket morphing aerial vehicle of claim 1, wherein the aerial vehicle is integrated with and partially within the rocket body.

10. The rocket morphing aerial vehicle of claim 9, wherein a portion of the aerial vehicle defines a portion of the rocket body.

11. The rocket morphing aerial vehicle of claim 10, wherein the deceleration mechanism comprises portions of the rocket body extending outward to create drag.

12. The rocket morphing aerial vehicle of claim 9, wherein the deceleration mechanism comprises a portion of the aerial vehicle and a portion of the rocket body.

13. The rocket morphing aerial vehicle of claim 12, wherein the aerial vehicle comprises a quad copter and the arms of the quad copter are curved in cross section to form the portion of the rocket body.

14. The rocket morphing aerial vehicle of claim 1, wherein the deceleration mechanism comprises portions of the rocket body extending outward to create drag.

15. A method of deploying an unmanned aerial vehicle using a rocket morphing aerial vehicle, comprising:
launching the rocket morphing aerial vehicle when the rocket morphing aerial vehicle is in a rocket configuration;
using a deceleration mechanism to slow the rocket morphing aerial vehicle; and
deploying the aerial vehicle.

16. The method of deploying an unmanned aerial vehicle of claim 15, wherein the deceleration mechanism is deployed when the rocket morphing aerial vehicle reaches a predetermined altitude.

17. The method of deploying an unmanned aerial vehicle of claim 15, wherein the deceleration mechanism is deployed near apogee of the rocket morphing aerial vehicle trajectory.

18. The method of deploying an unmanned aerial vehicle of claim 15, wherein the aerial vehicle is deployed by separating a portion of a rocket body and removing the aerial vehicle from within the rocket body.

19. The method of deploying an unmanned aerial vehicle of claim 15, wherein the aerial vehicle is deployed by extending portions of a rocket body to slow the rocket morphing aerial vehicle and the portions of the rocket body define portions of the aerial vehicle.

20. The method of deploying an unmanned aerial vehicle of claim 15, wherein the deceleration mechanism is a deforming of a portion of a rocket body from the rocket configuration.

21. The method of deploying an unmanned aerial vehicle of claim 15, wherein multiple aerial vehicles are launched from a single rocket configuration.
